(19) United States
(12) Patent Application Publication
(10) Pub. No.: US 2006/0031318 A1
(43) Pub. Date: Feb. 9, 2006

(54) Communicating information about the content of electronic messages to a server

(76) Inventor: Randall Coleman Gellens, San Diego, CA (US)

Correspondence Address: QUALCOMM, INC, 5775 MOREHOUSE DR., SAN DIEGO, CA, 92121, US

(21) Appl. No.: 10/868,301

(22) Filed: Jun. 14, 2004

(51) Int. Cl. G06F 15/16

(52) U.S. Cl. 709/206

(57) ABSTRACT

Described are techniques and mechanisms for addressing unsolicited commercial, junk, or generally unwanted electronic messages. Very generally stated, a message server is provided that performs a message filtering analysis using resources local to the message server. The message server delivers to a remote device messages that do not fail the filter. In the situation where the message filtering analysis was incorrect, the remote device returns a notification of that fact to the message server with sufficient information that the message server can update its local resources accordingly.

### BACKGROUND OF THE INVENTION

The invention relates generally to the field of telecommunications, and more particularly to systems and methods for improving the filtering of electronic messages.

Electronic messaging has become commonplace. It is widely available to users in the workplace, at home, and even on mobile devices like cellular phones and personal digital assistants. E-messaging takes very many forms, such as e-mail, instant messaging, Multimedia Messaging System (MMS) messages, and the like. As used throughout this document, the terms “e-messaging” and “messaging” will be used to include any form of electronic communication using messages, regardless of the particular format, structure, or protocols.

Unfortunately, the ubiquitous nature of e-messaging coupled with its relatively-low cost (and the ability for anyone to send a message to anyone else) has made unsolicited commercial e-messages—commonly referred to as “spam”—one of the most often cited nuisances of the technological age. Mobile devices are especially sensitive to spam because of their storage space constraints and bandwidth limitations, plus the difficulty of managing large numbers of messages on a small screen and with limited keys. In response, anti-spam filtering mechanisms are being developed to combat this plague. As forms of e-messaging such as MMS (Multimedia Messaging System) and mobile e-mail become more popular, spam is expected to be an increasing problem.

A recent development in the anti-spam battle is commonly referred to as “Bayesian” filtering. This involves maintaining two databases, one with words found in spam messages, and one with words found in non-spam messages. Note that these “words” usually include every element of a message; not just the text in the subject and body, but also messaging system protocol elements such as address headers, trace headers, host names, and the like. The Bayesian filter compares the words of a received message to the content of both databases, and assigns a spam score, or “spamicity,” to the received message based on that comparison. The spam score represents the estimated likelihood of the received message being spam, and is commonly a value between 0 (no likelihood) and 100 (certainty). The received message is typically identified as either spam or non-spam based on whether that spam score exceeds some (often user-determined) threshold. Bayesian filtering has been found to be enormously accurate provided the Bayesian filtering mechanism is properly “trained.” In other words, if a message is incorrectly identified (spam marked as non-spam, or non-spam marked as spam), the recipient should indicate the mistake to the Bayesian filter which then adjusts the databases accordingly. With sufficient training, Bayesian filtering has proven to be very successful. Moreover, it has been determined that the Bayesian filter is most effective on a particular system when the training is done with actual messages being delivered to that particular system.

Implementing Bayesian filtering on mobile devices has presented problems because of the storage space consumed by the Bayesian filter data stores and the processing needed to compare every word in the received message against the words in both databases. Common mobile devices, such as cellular phones, simply do not have sufficient storage to contain these data stores or need to use their storage for other items. This is somewhat of a dilemma because mobile device users are the ones most detrimentally impacted by spam. Unwanted e-mail consumes unnecessary bandwidth and may impact battery life because the mobile device is transmitting and receiving for longer periods to download the unwanted messages. The small screen size and limited keyboard generally makes it more frustrating for users to scan received messages, determine which are spam, and mark them for deletion. Unfortunately, an adequate solution to these problems has eluded those skilled in the art, until now.

### SUMMARY OF THE INVENTION

The invention is directed to techniques and mechanisms for enabling message filtering of the kind that may consume large amounts of resources, such as Bayesian filtering, to be performed on a server separate from a mobile device. Briefly stated, a spam filtering analysis is stored and performed on a server for electronic messages intended for delivery to a remote (possibly mobile) device. This feature allows the resources necessary for the performance of the filtering to reside on the server, thus preserving the resources of the (mobile or other) device.

In those cases where a message has been incorrectly identified and delivered, the mobile device allows the user to indicate this, and then returns notification information about that error to the server for inclusion in the message filtering mechanism. In this way, the message filtering mechanism can be continually trained to improved its accuracy. Likewise, if a message is incorrectly identified and not delivered, a user may, upon subsequent examination of the messages retained at the server, issue such an indication directly to the server so that the appropriate resources can be updated.

### BRIEF DESCRIPTION OF THE DRAWINGS

FIG. 1 is a functional block diagram generally illustrating a system for communicating e-mail messages from a server to a mobile device, and for communicating spam notifications from the mobile device to the server.

FIG. 2 is a functional block diagram generally illustrating in greater detail the e-mail system of the server illustrated in FIG. 1.

FIG. 3 is a functional block diagram generally illustrating in greater detail the mobile device portion of the system illustrated in FIG. 1.

FIG. 4 is a logical flow diagram generally illustrating the flow of information between a server and a mobile device to communicate information about unwanted messages.

FIG. 5 is a logical flow diagram generally illustrating a process that may be performed at a server according to the implementations described herein.

FIG. 6 is a logical flow diagram generally illustrating a process 600 that may be performed at a mobile device according to the implementations described herein.

### DETAILED DESCRIPTION

What follows is a detailed description of various techniques and mechanisms for addressing unsolicited commercial, junk, or generally unwanted electronic messages. Very generally stated, a message server performs a message filtering analysis using resources local to the message server. The message server delivers to a remote device messages that do not fail the filter. In the situation where the message filtering analysis was incorrect, the remote device returns a notification of that fact to the message server with sufficient information that the message server can update its local resources accordingly. Those skilled in the art will appreciate that teachings of this description may be embodied in various implementations that differ significantly from those described here without departing from the spirit and scope of the claimed invention.

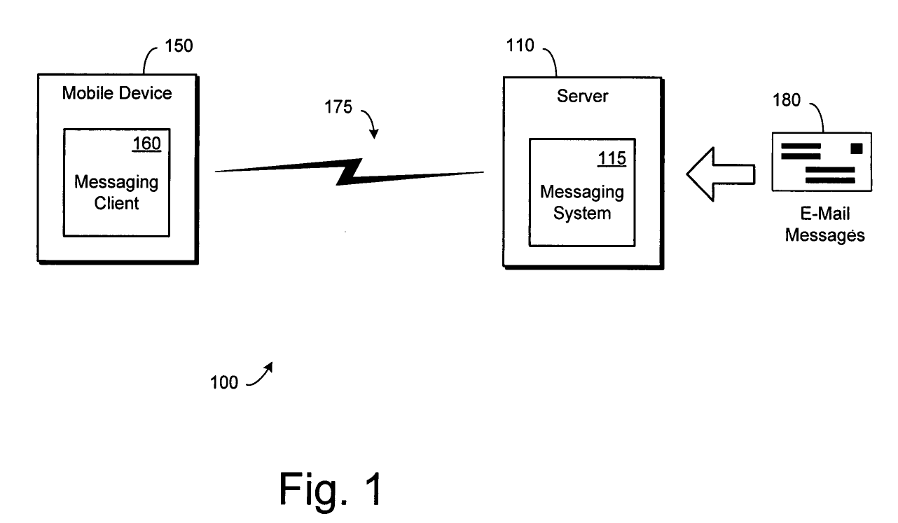

FIG. 1 is a functional block diagram generally illustrating a system 100 for communicating messages (such as email) from a server 110 to a mobile device 150, and for communicating spam notifications from the mobile device 150 to the server 110. As illustrated, the server 110 includes a messaging system 115 and may be any computing device configured to support the receipt of electronic messages 180 from various origins and directed at subscribers of the messaging system 115. In accordance with one implementation, the messaging system 115 on the server 110 maintains content identifying information for use in a spam message filtering system. More specifically, this disclosed embodiment includes two data stores typically used in a Bayesian e-mail filter, described in greater detail later.

The mobile device 150 includes a messaging client 160 and may be any device that presents computing functionality and communicates with a server remotely over a communications link. However, devices that benefit most from the techniques and mechanisms described here are typically mobile and either communicate with the server 110 over a communications link 175 of relatively low bandwidth and/or high latency, or are equipped with relatively limited storage space and/or processing power, or both. In one particular embodiment, the mobile device 150 may be a cellular telephone with integrated messaging capabilities. In this example, the mobile device 150 likely has both limited bandwidth and storage space. In another embodiment, the mobile device 150 could be a portable computer, personal digital assistant, or the like with greater storage and processing capacity but the same low bandwidth and/or high latency communications link. In still another embodiment, the mobile device 150 could be a stand-alone special purpose device with a greater bandwidth connection but yet may still have storage constraints. In yet another implementation, the device 150 may be some mobile or fixed device that has sufficient bandwidth and storage resources such as a remote desktop computer, but a user or administrator may simply desire to transfer the spam filtering burden from the device to the server 110.

As mentioned, the two systems communicate over a communications link 150, which is typically wireless. Alternatively, the communications link 175 may be a low-bandwidth or high-latency land line. In addition, although only a server 110 and the mobile device 150 are illustrated in the figures, it will be appreciated that many other components may be necessary to facilitate the communication link 174 between the server 110 and the mobile device 150, such as radio frequency transmitters and receivers, cellular towers, and the like.

The server 110 and the mobile device 150 communicate in accordance with a messaging protocol, such as Post Office Protocol (POP), Simple Message Transfer Protocol (SMTP), Internet Message Access Protocol (IMAP), and Multimedia Messaging Service (MMS), or the like. Alternatively, the two systems may communicate using an instant messaging service, or the like. Similarly, the mobile device 150 may initiate requests to learn of new messages from the server 110, or the mobile device 150 may be configured to accept asynchronous notifications of new messages from the server 110. In addition, the mobile device 150 and the server 110 may be configured such that the mobile device 150 requests delivery of specific messages it has been notified about, or all messages meeting some criteria, such as being new, below a certain size, and with a spam likelihood below a certain threshold, or the mobile device 150 and the server 110 may be configured such that messages meeting some criteria are asynchronously sent to the mobile device 150.

Briefly stated, the server 110 receives messages 180 intended for the user of the mobile device 150. The messaging system 115 determines a spam score for each incoming message 180 using resources available to the server, such as a Bayesian analysis engine and data stores. Messages having a spam score above a certain threshold are identified as spam and may be held at the server 110, while messages having a spam score below the threshold are made available for download to the mobile device 150.

If a message is improperly identified by the messaging system 115 and downloaded to the mobile device 150, components on the mobile device 150 allow the user to return a notification to the server 110 so that the messaging system 115 can update its resources (e.g., Bayesian data stores) appropriately. For example, a message may be improperly identified as non-spam and delivered to the mobile device 150. The user may return a notification of that fact to the server 110, allowing the messaging system 115 to update its resources accordingly. These techniques and mechanisms will be described next in greater detail.

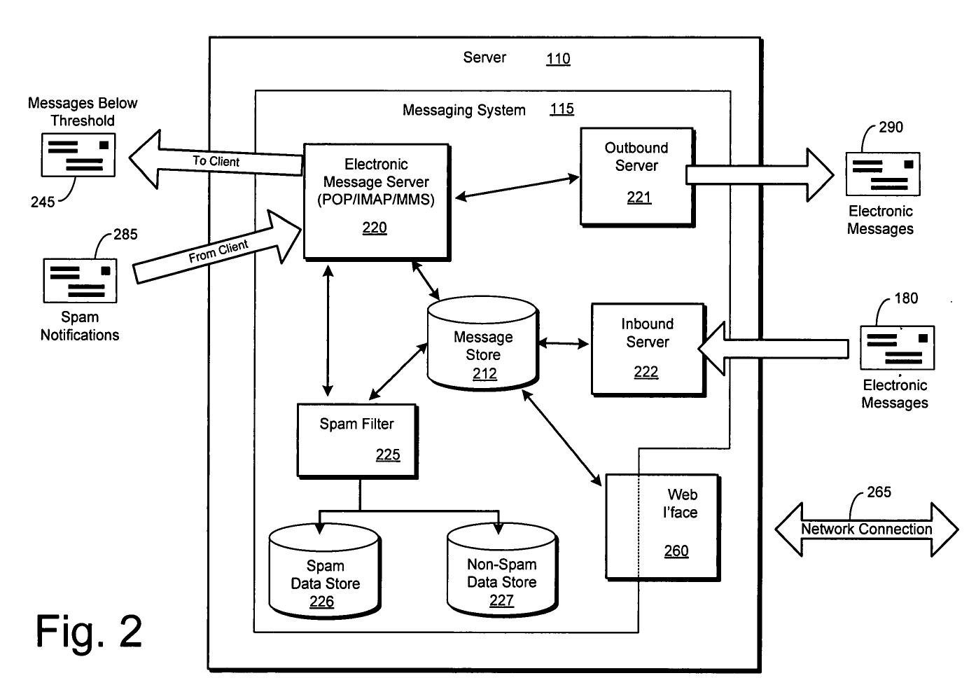

FIG. 2 is a functional block diagram generally illustrating in greater detail the messaging system 115 of the server 110 illustrated in FIG. 1. In this implementation, the messaging system 115 includes an inbound server 222 to receive incoming messages 180, and an outbound server 221 to deliver outgoing messages 290. The inbound server 222 places incoming messages 180 into a message store 212 where they can be accessed by other components of the messaging system 115. An electronic message server 220, such as a POP/IMAP/SMTP, or MMS server for example, interacts with a client on a remote device to make incoming messages 180 available to the client and to receive outbound messages 290 from the client for delivery by the outbound server 221. The message server 220 may communicate with the other components of the messaging system 115, such as a spam filter 225, and a web interface 260. The message server 220 performs the ordinary functions of receiving inbound e-mail messages 180 intended for a subscriber of the e-mail service. The message server 220 also makes available for download some or all of the inbound e-mail messages 180 to the subscriber.

The messaging system 115 also contains a spam filter 225 that interacts with the message server 220 and the message store 212, and is responsible for evaluating incoming messages to determine whether they are likely spam. In this particular implementation, the spam filter 225 does so by comparing the content of an incoming message 180, stored in the message store 212, to the content of a first data store 226 and a second data store 227. In this implementation, the spam filter 225 is configured to perform a Bayesian analysis to calculate a likelihood that the incoming message 180 is spam.

Briefly described, the spam filter 225 compares each word in the incoming message 180 to words stored in the Bayesian data stores. It should be noted here that the term “word” is used as an oversimplification of the way a Bayesian analysis works. For a proper Bayesian analysis, any parseable series of characters may be identified as a “word.” For example, “words” include any series of characters such as ordinary words, numbers, symbols, combinations of letters and/or numbers and/or symbols, Internet Protocol (IP) addresses, host names, Universal Resource Locators (URLs), prices, protocol elements (such as message headers, including trace headers), or any other combination of characters that may appear in a message. To avoid confusion, the term “token” will be used throughout the rest of this document in connection with this broader meaning of the term “word.”

Thus, the first data store 226 and the second data store 227 together include information related to the likelihood that a message is spam. In this embodiment, the first data store 226 is populated with tokens that occur in messages that have been identified as actual spam messages, and the second data store 227 is populated with tokens that occur in messages that have been identified as not being spam. The spam filter 225 computes a spam score, or “spamicity” value, that indicates a combined likelihood that the message is spam. In this particular embodiment, that spam score is calculated as a probability based on Bayes' Formula (simplified):

$$P ( {E}_{j} \vert F ) = \frac{P ( F \vert {E}_{j} ) P ( {E}_{j} )}{\sum P ( F \vert {E}_{i} ) P ( {E}_{i} )}$$

Using this technique, a cumulative likelihood that a message is spam is calculated by combining the probability associated with tokens in the message occurring in actual spam with the probability associated with tokens in the message occurring in non-spam. Messages having a calculated spam score exceeding some threshold are identified as spam, and the remaining messages are not identified as spam. There may also be multiple thresholds which result in different actions.

It is envisioned that messages (245) not identified as spam are made available to the mobile device for retrieval. Messages identified as spam may be specially tagged or moved to a particular location for spam within the message store 212. Depending on the particular messaging technology, the messaging system 115 may simply store all messages at the server 110 until a session is established by the mobile device and then make the non-spam messages 245 available. Alternatively, the messaging system 115 may include a mechanism for pushing the messages 245 out to the mobile device.

The messaging system 115 is configured to receive a notification 285 that a message 245 was improperly identified. More specifically, if the messaging system 115 incorrectly fails to identify an incoming message 180 as spam, and that message is retrieved by the mobile device, the user of the mobile device can cause the client on the device to return a spam notification 285 that allows the messaging system 115 to appropriately update the Bayesian data stores. In many cases, the spam notification 285 will contain one or more identifiers for the messages which have been incorrectly identified as spam or as non-spam. The specific form of identifier depends on the messaging protocol in use and may in some cases be a URL or a protocol-specific identifier. For example, both POP and IMAP allow messages to be referred to using either session-specific identifiers or longer-lived unique identifiers. In some specific implementations, the spam notification 285 may include the entire message that was incorrectly identified. Alternatively, the spam notification 285 may include only the tokens from the message.

Once the spam notification 285 is received, the spam filter 225 incorporates that information in the proper data store. In the case where the message (245) is incorrectly identified as non-spam, tokens identified in the spam notification 285 would be included in the spam-related (first) data store 226. In this way, Bayesian filtering can be performed on the server 110 rather than on the mobile device, yet errors can still be communicated from the mobile device back to the messaging system 115 on the server 110, thus enabling the spam filter 225 to be continually trained.

The server 110 may also include a Web interface 260 that interacts with the messaging system 115 and external systems over a wide area network connection 265 to make functionality on the server 110 publicly accessible. The Web interface 260 allows users to access their e-mail stored in the message store 212 while connected over the Internet or other wide area networking technology. It should be noted that the user could, but need not, be using the mobile device to connect to the server 110 using the Web interface 260. Using the Web interface 260, the user can connect to the messaging system 115 and examine any messages that were marked as spam and not downloaded to the mobile device. If any messages were incorrectly identified as spam (i.e., “false positives”), the user can indicate that information to the messaging system 115 through the Web interface 260, thus enabling the spam filter 225 to be trained on false positives as well.

In some specific implementations, the user may set the spam threshold at different values depending on factors such as if the user is roaming, if the signal strength is good, if the user is in a hurry, and so on. Thus, the user may be aware of messages in some cases, using a higher spam threshold, than in other cases, using a lower spam threshold. In those cases where a spam threshold is used which permits downloading potential spam messages, the user may identify false positives and use the client 160 on the device 150 (FIG. 1) to notify the server 110 about the error. In these cases, spam notification 285 may indicate messages which were incorrectly identified as spam, as well as, in addition to, or instead of, indicating messages which were incorrectly identified as not spam.

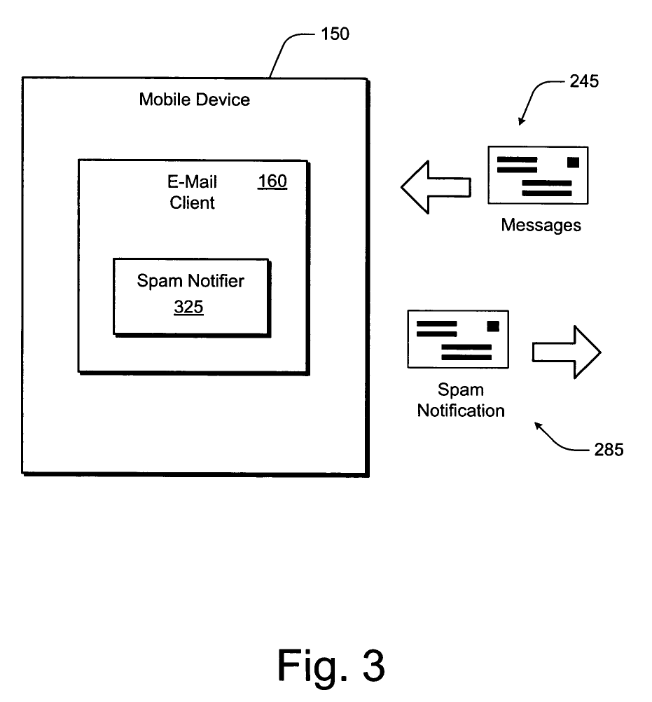

FIG. 3 is a functional block diagram generally illustrating in greater detail the mobile device 150 illustrated in FIG. 1. The mobile device 150 may include several applications, including a messaging client 160 which contains a spam notifier 325. The mobile device 150 may also include browsing software (not shown). Although the messaging client 160 could be configured to use any type of messaging protocol, in this particular implementation the messaging client 160 is configured with conventional e-mail client functions, such as receiving and composing e-mail messages, and the like. The messaging client 160 in configured to interact with the message server 220, and so may receive messages 245 from the server 110 (FIG. 2). In addition, the messaging client 160 invokes the spam notifier 325 in the case where one or more of the incoming messages 245 were actually spam but slipped through the spam filter 225 (FIG. 2). In this case, the user instructs the client 160 to activate the spam notifier 325 to issue a spam notification 285 back to the server.

The particular mechanism for activating the spam notifier 325 could take many forms. In one example, the spam notifier 325 may be activated by simply clicking a button or menu item while viewing the incorrectly identified message. This action may cause the spam notifier 325 to create and return the spam notification 285 to the server.

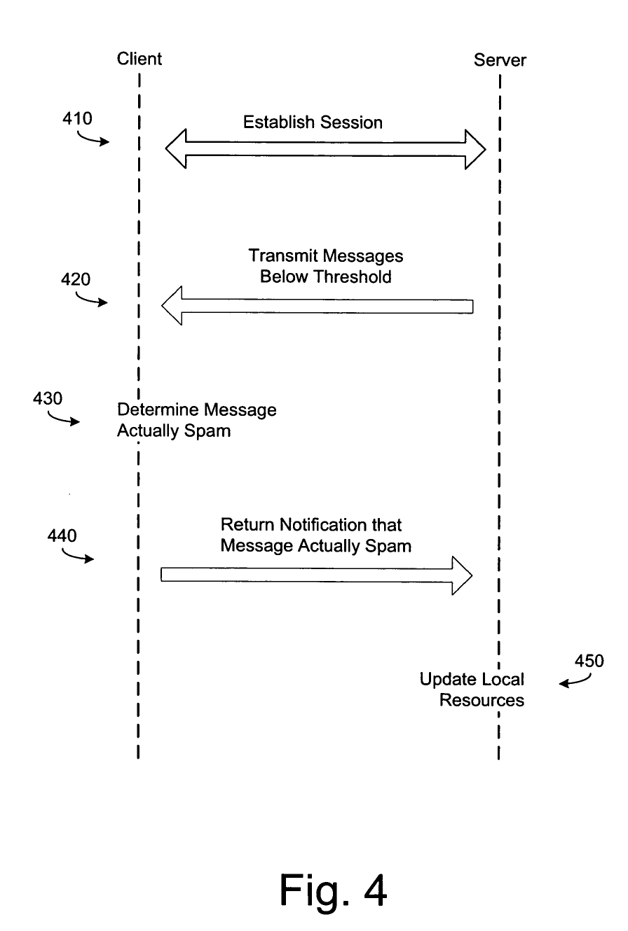

FIG. 4 is an operational flow diagram illustrating generally the flow of messages between the mobile device (Client) and the server. To begin, at step 410, the client and server initiate a session so that electronic messages may be made available to the client. Next, at step 420, messages for which the spam score is below some threshold (and possibly matching other criteria as well) are transmitted to the client. As discussed above, it is envisioned that the spam score is generated by evaluating the messages against one or more data stores having spam-related content. In particular, a Bayesian analysis may be performed using data stores at the server having spam-related content and non-spam related content.

At step 430, it is determined at the client that a message retrieved from the server was incorrectly identified as non-spam. In other words, a message that had a spam score below the threshold was in fact determined to be spam. In this case, at step 440, a return notification of that fact may be issued to the server. The notification should either include the token information from the incorrectly-identified message or identify the message sufficiently that the server may retrieve the token information directly (e.g., in the case where messages may continue to be stored at the server). In cases where messages with a relatively high spam score are delivered to the client (such as by request of the user), the user may determine that some messages were incorrectly identified as spam. In such cases, step 430 may involve a determination that a message is actually not spam and step 440 would involve notification to the server that the message(s) were actually not spam.

At step 450, the server updates its local resources to reflect the notification that the message was actually spam (or, in some cases, that the message is actually not spam). In the situation where a Bayesian analysis is being performed, the token information from the message may be included in a data store for content related to spam messages (or, in some cases, a data store for content related to not-spam messages).

Training the Bayesian data stores in this fashion, using actual messages delivered to the client, helps to greatly improve the accuracy of the filtering mechanism. In addition, by locating the filtering mechanism on a server that serves multiple users, the filtering mechanism can be trained much more quickly than if resident only on a single remote device. And the aggregated training that is performed is not necessarily inferior to the training achieved with messages intended for a single subscriber. This is because the several users of the same server are likely to receive messages having similar characteristics. For instance, two lawyers are more likely to receive messages that are similar than would, say, a doctor and a lawyer. Accordingly, the training received by a server-side filtering mechanism in a law firm, with messages largely intended for the same class of subscriber, would likely be superior to a generic pre-training of the filtering mechanism.

By way of example, what follows is a pseudo-code representation of a sample exchange between the mobile device and the server to communicate token information about a message. The pseudo-code is loosely based on an exchange between a client and a POP e-mail server. POP is chosen only for illustrative purposes because of the simplicity of the protocol. In this example, a spam message having a spam score below a threshold is delivered to the mobile device. Accordingly, the user of the mobile device initiates an operation to communicate the message identification back to the server. The following table includes a simplified sample exchange that may occur between the mobile device (C:) and the server (S:) to accomplish that operation:

| Dev. | Commands | Description |
|---|---|---|
| C:/S: | {session initiation) | A connection is established between |
| | | the client and the server. For example, |
| | | a TCP connection is opened and a |
| | | protocol banner is sent from the server |
| | | to the client. |
| C:/S: | {authentication} | Some operations and exchanges to |
| | | authenticate the mobile device with the |
| | | server and open a session. |
| S: | (Acknowledges | The server informs the client that it has |
| | authentication and lists | been authenticated, and returns to the |
| | number of messages) | mobile device a listing of the number of |
| | | new messages. |
| C: | UIDL | The mobile device requests unique |
| | | identifiers for each message. |
| S: | 1 XYZ 1 | The server returns a list including a |
| | 2 XYZ 2 | unique identifier for each message, and |
| | 3 XYZ 3 | may also include some additional meta |
| | | information about each message. |
| C: | RETR 2 | The mobile device issues an instruction |
| | | to retrieve message number 2. |
| C: | DELE 1 | The mobile device issues an instruction |
| | | to delete message number 1. |
| S: | (Send 2) | The server transmits message number |
| | | 2 to the mobile device. |
| S: | OK message 1 deleted | The server acknowledges that message |
| | | number 1 has been deleted. |
| C: | SPAM 2 | The mobile device issues a return |
| | | message that message number 2 was |
| | | actually spam. |
| S: | OK SPAM 2 | Server acknowledges the notification |
| | | that message number 2 was actually |
| | | spam. |

Note that the mobile device issues a return message notifying the server that message number two was actually a spam message. That return message may take many forms. As mentioned above, the spam notification in many cases will include a reference to the messages to be marked as spam or marked as non-spam as well as an indication as to whether the messages should be marked as spam or as not-spam.

In some implementations, the notification may include the entire content of the incorrectly identified message. Alternatively, the spam notification may include some simplified or compressed version of the message to conserve bandwidth, such as only the tokens from the message. In addition, the spam notifier may include the original message as an attachment to the spam notification or inline in the notification itself. For instance, the return message may include an attached copy of the original message, allowing the server to parse tokens from the original message and add those tokens to the spam (first) data store 226 (FIG. 2).

In cases where messages may be stored on the server for a period of time sufficient for the user to have a chance to review the message and make a determination as to if it is spam or not, the return message may include an identification of the message at the server, allowing the spam filter to parse the stored version of the message for tokens. This further reduces the amount of traffic transmitted between the mobile device and the server.

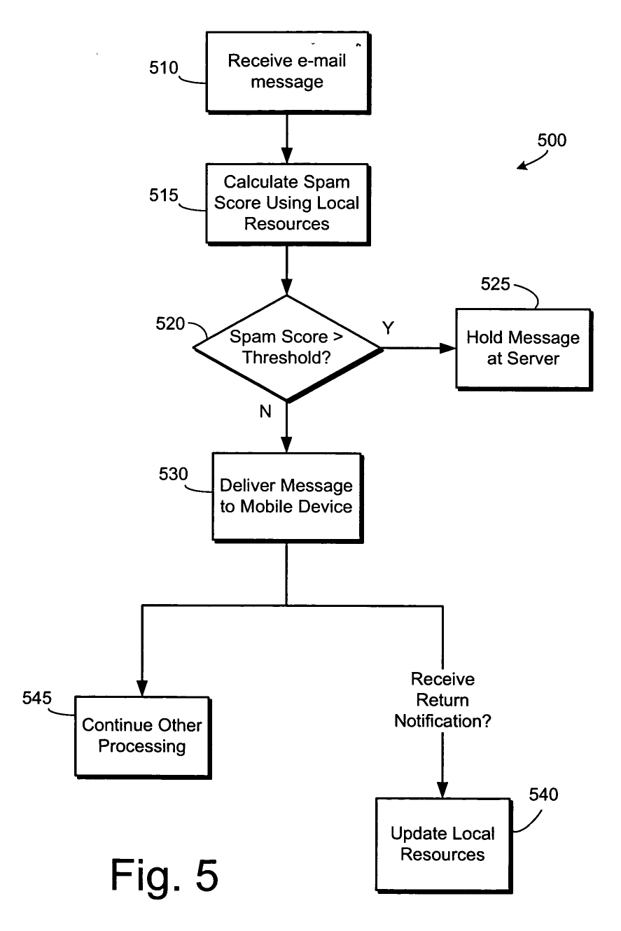

FIG. 5 is a logical flow diagram generally illustrating a process 500 that may be performed at a server according to the implementations described above. The process 500 begins at block 510, where a server receives an electronic message intended for a subscriber of a messaging service provided by the server. At block 515, the server calculates a spam score for the message. In one implementation, the spam score is calculated using a Bayesian analysis based on resources local to the server. More specifically, the local resources may include a spam data store having tokens found in spam messages, and a non-spam data store having tokens found in non-spam messages.

At block 520, if the spam score for the message exceeds a certain threshold, the message is held at the server (block 525), perhaps in a special message store, or the like. If the spam score is below the threshold, the message is delivered to a mobile device (block 530) associated with the subscribed user.

The server may receive a return notification that the delivered message was in fact spam. It will be appreciated that the server likely does not perform any affirmative actions in this determination, but rather may potentially receive such a notification asynchronously. Thus, the server may perform many other operations (block 545) unrelated to this process 500 until such a notification is received, such as the evaluation and delivery of other messages. However, if a notification is received that the message was in fact spam, then, at block 540, the server updates its local resources to reflect that notification. As described in detail above, the notification may take many forms, including a return message from the mobile device including the content of the original message. Many alternative forms will become apparent to those skilled in the art.

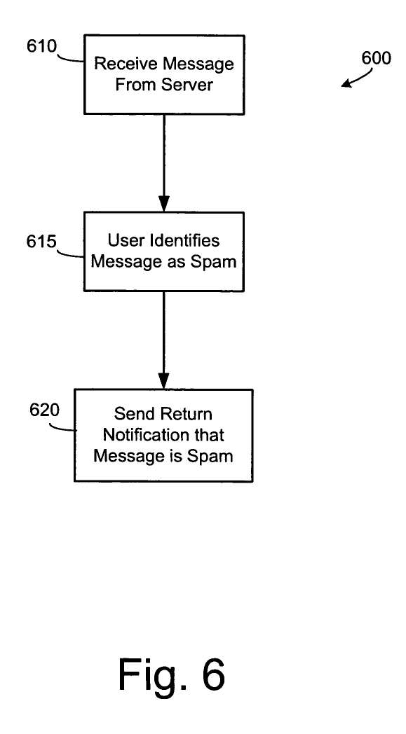

FIG. 6 is a logical flow diagram generally illustrating a process 600 that may be performed at a mobile device according to the implementations described above. The process 600 begins at block 610, where a mobile device receives an electronic message from a server. The message may be received in accordance with any electronic messaging protocol, including any e-mail or other messaging protocol, such as instant messaging or MMS.

At block 615, a user of the mobile device identifies the message as being spam. This identification may be performed in many ways. It is envisioned that the user employs ordinary human analysis to determine that the message is categorized as spam. However, an automated analysis could also be performed at the mobile device, such as a rules-based analysis or the like. At block 620, based on identifying the message as spam, a return notification that the message is spam is sent to the server. This return notification will likely include a reference to or identification of the message, but may include the original message as an attachment, in one example, or the notification may include information about the original message, such as tokens extracted from the original message. The notification may also take many other forms too numerous to recite here.

While the present invention has been described with reference to particular embodiments and implementations, it should be understood that these are illustrative only, and that the scope of the invention is not limited to these embodiments. Many variations, modifications, additions and improvements to the embodiments described above are possible. It is contemplated that these variations, modifications, additions and improvements fall within the scope of the invention as detailed within the following claims.

I claim:

1. A computer-implemented method for communicating information about content of an electronic message to a server, the method comprising:
receiving at a remote device an electronic message that includes tokens;
receiving an indication that the electronic message has been improperly identified by the server; and
issuing a return message to the server that the message has been improperly identified, the notification including sufficient information for the server to include the tokens in a resource local to the server.

2. The method recited in claim 1, wherein the tokens comprise any parseable series of characters within the electronic message.

3. The method recited in claim 2, wherein the tokens include ordinary words, numbers, combinations of letters and numbers, Internet Protocol addresses, host names, Universal Resource Locators, prices, symbols, and protocol elements.

4. The method recited in claim 1, wherein the remote device comprises a mobile device.

5. The method recited in claim 4, wherein the mobile device comprises a portable telephone.

6. The method recited in claim 1, wherein the remote device comprises a portable computer.

7. The method recited in claim 1, wherein the remote device comprises a remote desktop computer.

8. The method recited in claim 1, wherein the electronic message comprises an e-mail message.

9. The method recited in claim 1, wherein the electronic message comprises an MMS message.

10. The method recited in claim 1, wherein the electronic message comprises an instant messaging message.

11. The method recited in claim 1, wherein the indication that the message has been improperly identified comprises an instruction by a user to identify the electronic message as spam.

12. The method recited in claim 11, wherein the return message comprises a notification that the electronic message is a spam message, and wherein the improper identification comprises an identification that the message is not spam.

13. The method recited in claim 11, wherein the return message comprises a notification that the electronic message is not a spam message, and wherein the improper identification comprises an identification that the message is spam.

14. A computer-readable medium having computer-executable instructions for communicating information about content of an electronic message to a server, the instructions comprising:
receiving at a remote device an electronic message that includes a plurality of parseable series of characters;
receiving an indication that the electronic message comprises a spam message; and
issuing a return message to the server that the electronic message comprises the spam message and including in the return message the plurality of parseable series of characters for inclusion in a data store, local to the server and used by the server in an analysis of a spamicity of electronic messages.

15. A computer-implemented method for updating local resources to include additional information related to an analysis of incoming messages for spamicity, the method comprising:
analyzing an electronic message to calculate a spamicity value for the electronic message, the analysis being based on at least one data store that includes tokens found in messages, the tokens being characterized as either having occurred in spam messages or having occurred in non-spam messages;
making a decision whether the electronic message is spam based on the calculated spamicity value;
delivering the electronic message to a remote device; and
receiving a notification from the remote device that the decision was incorrect, the notification including sufficient information about the electronic message to update the at least one data store to include tokens from the electronic message.

16. The method recited in claim 15, wherein the tokens comprise any parseable series of characters.

17. The method recited in claim 15, wherein the tokens include ordinary words, numbers, combinations of letters and numbers, Internet Protocol addresses, host names, Universal Resource Locators, prices, symbols, and protocol elements.

18. The method recited in claim 15, wherein the remote device comprises a mobile device.

19. The method recited in claim 18, wherein the mobile device comprises a portable telephone.

20. The method recited in claim 15, wherein the remote device comprises a portable computer.

21. The method recited in claim 15, wherein the remote device comprises a remote desktop computer.

22. The method recited in claim 15, wherein the electronic message comprises an e-mail message.

23. The method recited in claim 15, wherein the electronic message comprises an MMS message.

24. The method recited in claim 15, wherein the electronic message comprises an instant messaging message.

25. The method recited in claim 15, wherein the analysis comprises a Bayesian analysis.

26. The method recited in claim 15, wherein the at least one data store includes a first component containing tokens found in messages determined to be spam, and a second component containing tokens found in messages determined not to be spam.

27. The method recited in claim 15, wherein the notification comprises an identifier of the electronic message if the electronic message is stored at the server.

28. The method recited in claim 15, wherein the decision is made by comparing the calculated spamicity to a pre-determined threshold.

29. The method recited in claim 15, wherein the sufficient information comprises the tokens from the electronic message.

30. The method recited in claim 15, wherein the sufficient information comprises an identifier for the electronic message if the electronic message is stored at the server.

31. The method recited in claim 15, wherein the sufficient information comprises a copy of the electronic message.
